(19) United States
(12) Patent Application Publication
(10) Pub. No.: US 2007/0042928 A1
(43) Pub. Date: Feb. 22, 2007

(54) Solid laundry detergent composition comprising an alkyl benzene sulphonate-based anionic detersive surfactant system and a chelant system

(75) Inventors: Doris Appleby, Newcastle-upon-Tyne (GB); Alan Thomas Brooker, Newcastle-upon-Tyne (GB)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/505,006

(22) Filed: Aug. 16, 2006

(30) Foreign Application Priority Data
Aug. 19, 2005 (EP) 05018029.8

(51) Int. Cl. C11D 17/00

(52) U.S. Cl. 510/444

(57) ABSTRACT

The present invention relates to a solid laundry detergent composition in particulate form, the composition comprises: (i) an anionic detersive surfactant system that comprises at least 50%, by weight of the anionic detersive surfactant system, of alkyl benzene sulphonate; (ii) a source of peroxygen that is preferably at least partially coated by a coating ingredient; (iii) a chelant; (iv) from 0% to less than 5%, by weight of the composition, of zeolite builder; (v) from 0% to less than 5%, by weight of the composition, of phosphate builder; and (vi) optionally from 0% to less than 5%, by weight of the composition, of silicate salt; wherein the chelant has a metal ion chelation efficacy such that at pH 10.0, 0:1M NaCl and 25° C.: (i) the ratio of the chelant's stability constant (log K) for Cu²⁺ cation to the chelant's stability constant (log K) for Ca²⁺ cation is greater than 1:1; (ii) the ratio of the chelant's stability constant (log K) for Fe³⁺ cation to the chelant's stability constant (log K) for Ca²⁺ cation is greater than 1:1; (iii) the ratio of the chelant's stability constant (log K) for Ni²⁺ cation to the chelant's stability constant (log K) for Ca²⁺ cation is greater than 1:1.

### FIELD OF THE INVENTION

The present invention relates to a solid laundry detergent compositions comprising a chelant system having a predominantly transition metal cation-chelating efficacy under alkaline pH conditions. The compositions of the present invention additionally comprise a bleach-compatible, predominantly alkyl benzene sulphonate-based, anionic detersive surfactant system and a coated peroxygen source; and exhibit good bleach stability and performance, and good overall cleaning performance.

### BACKGROUND OF THE INVENTION

There have been relatively recent attempts by many detergent manufacturers to significantly improve the dissolution and dispensing performance of their granular laundry detergents. The approach many detergent manufacturers have focused on is the significant reduction in the level of, or even the complete removal of, water-insoluble builder, such as zeolite builder, in/from their granular laundry detergent formulations. However, due to the phosphate-usage avoidance legislation in many countries which prevents the detergent manufacturers from incorporating a sufficient amount of phosphate-based water-soluble builders, such as sodium tripolyphosphate, in their granular laundry detergents, and due to the lack of feasible alternative non-phosphate based water-soluble builders available to the detergent manufacturers, the approach many detergent manufacturers have focused on is to not completely replace the zeolite-based builder system with a water-soluble builder system having an equivalent degree of builder capability, but instead to formulate an under-built granular laundry detergent composition.

Whilst this under-built approach does significantly improve the dissolution and dispensing performance of the granular laundry detergent, problems do exist due to the significant amount of cations, such as calcium, that are not removed from the wash liquor by the builder-system of the granular laundry detergent composition during the laundering process. These cations interfere with the anionic detersive surfactant system of the granular laundry detergent composition in such a manner as to cause the anionic detersive surfactant to precipitate out of solution, which leads to a reduction in the anionic detersive surfactant activity and cleaning performance. In extreme cases, these water-insoluble complexes may deposit onto the fabric resulting in poor whiteness maintenance and poor fabric integrity benefits. This is especially problematic when the laundry detergent is used in hard-water washing conditions when there is a high concentration of calcium cations.

One approach the detergent manufacturers have focused on to overcome or ameliorate the problem of the poor cleaning performance of under-built granular laundry detergent compositions, due to the presence of a high concentration of calcium cations in the wash liquor, is through the use of chelants that predominantly chelate calcium cations as opposed to other metal cations. Examples of such chelants include: diethylene triamine penta (methylene phosphonic) acid; diethylene triamine penta acetate; and ethylene diamine tetra (methylene phosphonic) acid.

However, the Inventors have found that the incorporation of a chelant having a specific cation chelation efficacy, into an under-built granular laundry detergent composition that comprises a bleach-compatible, predominantly alkyl benzene sulphonate-based, anionic detersive surfactant system and a coated peroxygen source significantly improves the cleaning performance of the solid laundry detergent composition. The Inventors have found that, contrary to the above-described approach of using chelants having a predominantly calcium cation-chelating efficacy, the chelant must, under typical alkaline pH conditions, predominantly chelate transition metal cations relative to Ca²⁺ cations; a suitable chelant for use in the present invention is ethylene diamine-N,N′-disuccinic acid.

U.S. Pat. No. 5,552,078 by Carr et al, Church & Dwight Co. Inc., relates to a powdered laundry detergent composition comprising an active surfactant, at least 70 wt % of a water-soluble alkaline carbonate salt, e.g. sodium carbonate, from 0.1 wt % to 2 wt % of a phosphate-builder, e.g. sodium tripolyphosphate, from 0.1 wt % to 2 wt % of a carboxylate polymer, and from 1 wt % to 12 w of water. It is alleged that compositions of U.S. Pat. No. 5,552,078 exhibit excellent cleaning and whitening of fabrics whilst avoiding the problem of eutrophication which occurs when a substantial amount of phosphate-builder is present in the composition, and while minimizing the problem of fabric-encrustation often present when the composition contains a large amount of carbonate builder. However, the compositions of U.S. Pat. No. 5,552,078 are bleach-free and, in addition, do not comprise any chelant that predominantly chelates transition metal cations relative to Ca²⁺ cations; instead U.S. Pat. No. 5,552,078 describes the use of other chelants such as diethylene triamine penta (methylene phosphonic) acid and ethylene diamine tetra (methylene phosphonic) acid that predominantly chelate calcium cations as opposed to other metal cations.

U.S. Pat. No. 6,274,545 B1 by Mazzola, Church & Dwight Co. Inc., relates to a high-carbonate low-phosphate powder laundry detergent formulation which can allegedly be utilized in cold water fabric laundering with a minimized remainder of undissolved detergent residue in the wash liquor. The detergent composition of U.S. Pat. No. 6,274,545 B1 comprises an anionic/nonionic surfactant blend that is a partially sulphated and neutralized ethoxylated alcohol surfactant, and a polyethylene glycol ingredient, which allegedly increases the solubility of the laundry detergent solids in the wash liquor. However, the compositions of U.S. Pat. No. 6,274,545 B1 are bleach-free, and, in addition, do not comprise any chelant that predominantly chelates transition metal cations relative to Ca²⁺ cations.

WO97/43366 by Askew et al, The Procter & Gamble Company, relates to a detergent composition that comprises an effervescence system. WO97/43366 exemplifies a carbonate built bleach-free detergent composition.

WO00/18873 by Hartshorn et al, The Procter & Gamble Company, relates to detergent compositions having allegedly good dispensing performance and allegedly do not leave residues on the fabric after the laundering process.

WO00/18859 by Hartshorn et al, The Procter & Gamble Company, relates to detergent compositions allegedly having an improved delivery of ingredients into the wash liquor during the laundering process. The compositions of WO00/18859 allegedly do not as readily gel upon contact with water and allegedly do not leave water-insoluble residues on clothes after the laundering process. The compositions of WO00/18859 comprise a predominantly water-soluble builder system that is intimately mixed with a surfactant system

WO02/053691 by Van der Hoeven et al, Hindustain Lever Limited, relates to a laundry detergent composition comprising greater than 10 wt % of a calcium tolerant surfactant, from 0.1 wt % to 10 wt % of a strong builder system selected from phosphate builders and/or zeolite builders, and less than 35 wt % of non-functional non-alkaline water-soluble inorganic salts. Although the compositions of W002/053691 comprise low levels of zeolite-builders and phosphate-builders, they allegedly remain robust across a wide range of water hardness. However, the surfactant system of WO02/053691 is a predominantly alpha-olefin sulphonate-based anionic surfactant system and as such is not bleach compatible due to the presence of an alkene moiety in the alpha-olefin sulphonate. In addition, WO02/053691 teaches away from the use of a predominantly alkyl benzene sulphonate-based anionic surfactant due to an alleged calcium intolerancy of alkyl benzene sulphonate.

### SUMMARY OF THE INVENTION

In a first embodiment, the present invention provides a solid laundry detergent composition in particulate form, the composition comprises: (i) an anionic detersive surfactant system that comprises at least 50%, by weight of the anionic detersive surfactant system, of alkyl benzene sulphonate; (ii) a source of peroxygen that is preferably at least partially coated by a coating ingredient; (iii) a chelant; (iv) from 0% to less than 5%, by weight of the composition, of zeolite builder; (v) from 0% to less than 5%, by weight of the composition, of phosphate builder; and (vi) optionally from 0% to less than 5%, by weight of the composition, of silicate salt; wherein the chelant has a metal ion chelation efficacy such that at pH 10.0, 0.1M NaCl and 25° C.: (i) the ratio of the chelant's stability constant (log K) for Cu²⁺ cation to the chelant's stability constant (log K) for Ca²⁺ cation is greater than 1:1; (ii) the ratio of the chelant's stability constant (log K) for Fe³⁺ cation to the chelant's stability constant (log K) for Ca²⁺ cation is greater than 1:1; (iii) the ratio of the chelant's stability constant (log K) for Ni²⁺ cation to the chelant's stability constant (log K) for Ca²⁺ cation is greater than 1:1.

In a second embodiment, the present invention provides a solid laundry detergent composition in particulate form, the composition comprises: (i) an anionic detersive surfactant system that comprises at least 50%, by weight of the anionic detersive surfactant system, of a linear or branched, substituted or unsubstituted, C₈₋₁₈ alkyl benzene sulphonate; (ii) a source of peroxygen that is preferably at least partially coated by a coating ingredient; (iii) ethylene diamine-N,N′-disuccinic acid; (iv) from 0% to less than 5%, by weight of the composition, of zeolite builder; (v) from 0% to less than 5%, by weight of the composition, of phosphate builder; and (vi) optionally from 0% to less than 5%, by weight of the composition, of silicate salt.

### DETAILED DESCRIPTION OF THE INVENTION

Solid Laundry Detergent Composition

The composition comprises an anionic detersive surfactant system, a source of peroxygen, a chelant, from 0% to less than 5%, by weight of the composition, of zeolite builder, from 1% to less than 5%, by weight of the composition, of phosphate builder, optionally from 0% to less than 5%, by weight of the composition, of silicate builder, and optionally other adjunct ingredients. The composition preferably comprises adjunct ingredients.

The composition is in particulate form, such as an agglomerate, a spray-dried power, an extrudate, a flake, a needle, a noodle, a bead, or any combination thereof. The composition may be in compacted-particulate form, such as in the form of a tablet. The composition may be in some other unit dose form, such as in the form of the pouch, typically being at least partially, preferably completely enclosed with a water-soluble film such as polyvinyl alcohol. Preferably, the composition is in free-flowing particulate form; by free-flowing particulate form, it is typically meant that the composition is in the form of separate discrete particles. The composition may be made by any suitable method including agglomeration, spray-drying, extrusion, mixing, dry-mixing, liquid spray-on, roller compaction, spheronisation or any combination thereof.

The composition typically has a bulk density of from 450 g/l to 1,000 g/l, preferred low bulk density detergent compositions have a bulk density of from 550 g/l to 650 g/l and preferred high bulk density detergent compositions have a bulk density of from 750 g/l to 900 g/l. During the laundering process, the composition is typically contacted with water to give a wash liquor having a pH of from above 7 to less than 13, preferably from above 7 to less than 10.5. This is the optimal pH to provide good cleaning whilst also ensuring a good fabric care profile.

Preferably, the chelant and the source of peroxygen are present in the composition in the form of separate particulate components, and wherein the ratio of the porosity of the particulate component comprising the chelant to the porosity of the particulate component comprising the source of peroxygen is at least greater than 1:1, preferably greater than 2:1, or greater than 3:1, or greater than 4:1, or even greater than 5:1. The porosity of the particulate components is typically determined by mercury porosimetry using a sieved particulate size range of 250-300 micrometers and where only pores of less than 30 micrometers are considered for the determination of porosity. More details of mercury porosimetry can be found in: “Analytical methods of fine particle technology” by Webb, P. and Orr, C., Micromeretics Instrument Corporation, Norcross, Ga., USA; ISBM 0-9656783-0-X. Only pores of less than 30 micrometers are considered for the determination of porosity in order to avoid the inclusion of unwanted inter-particulate porosity in the calculations to determine the porosity of the particulate components. Any suitable mercury porosimetry method and equipment can be used.

Preferably, the particle size distribution of the chelant and source of peroxygen is such that the ratio of the weight average particle size of the particulate component comprising the chelant to the weight average particle size of the particulate component comprising the source of peroxygen is in the range of from 0.0001:1, or from 0.001:1, or from 0.01:1, or from 0.1:1, and to 1000:1, or to 100:1, or to 10:1. Without wishing to be bound by theory, it is believed that these preferred particle size ratios ensure good bleach stability.

Preferably, the chelant is present in the composition in the form of a co-particulate admix with an anionic detersive surfactant, preferably a linear or branched, substituted or unsubstituted C₁₂₋₁₈ alkyl ethoxylated sulphate having an average degree of ethoxylation of from 1 to 10, more preferably a linear unsubstituted C₁₂₋₁₈ alkyl ethoxylated sulphate having an average degree of ethoxylation of from 3 to 7. Without wishing to be bound by theory, it is believed having the chelant in the form of a co-particulate admix with an anionic detersive surfactant ensures that the composition has a good cake strength.

The composition typically has an equilibrium relative humidity of from 0% to less than 30%, preferably from 0% to 20%, when measured at a temperature of 35° C. Typically, the equilibrium relative humidity is determined as follows: 300 g of composition is placed in a 1 litre container made of a water-impermeable material and fitted with a lid capable of sealing the container. The lid is provided with a sealable hole adapted to allow insertion of a probe into the interior of the container. The container and its contents are maintained at a temperature of 35° C. for 24 hours to allow temperature equilibration. A solid state hygrometer (Hygrotest 6100 sold by Testoterm Ltd, Hapshire, UK) is used to measure the water vapour pressure. This is done by inserting the probe into the interior of the container via the sealable hole in the container's lid and measuring the water vapour pressure of the head space. These measurements are made at 10 minute intervals until the water vapour pressure has equilibrated. The probe then automatically converts the water vapour pressure reading into an equilibrium relative humidity value.

Preferably, the composition upon contact with water at a concentration of 9.2 g/l and at a temperature of 20° C. forms a transparent wash liquor having (i) a turbidity of less than 500 nephelometric turbidity units; and (ii) a pH in the range of from 8 to 12. Preferably, the resultant wash liquor has a turbidity of less than 400, or less than 300, or from 10 to 300 nephelometric turbidity units. The turbidity of the wash liquor is typically measured using a Hl 93703 microprocessor turbidity meter. A typical method for measuring the turbidity of the wash liquor is as follows: 9.2 g of composition is added to 1 litre of water in a beaker to form a solution. The solution is stirred for 5 minutes at 600 rpm at 20° C. The turbidity of the solution is then measured using a H1 93703 microprocessor turbidity meter following the manufacturer's instructions.

Chelant

The composition comprises a chelant. The chelant has a metal ion chelation efficacy such that (i) the ratio of the chelant's stability constant (log K) for Cu²⁺ cation to the chelant's stability constant (log K) for Ca²⁺ cation is greater than 1:1, preferably greater than 2:1, or greater than 3:1; (ii) the ratio of the chelant's stability constant (log K) for Fe³⁺ cation to the chelant's stability constant (log K) for Ca²⁺ cation is greater than 1:1, preferably greater than 2:1, or greater than 3:1; (iii) the ratio of the chelant's stability constant (log K) for Ni²⁺ cation to the chelant's stability constant (log K) for Ca²⁺ cation is greater than 1:1, preferably greater than 2:1, or greater than 3:1. If the chelant is capable of chelating more than one metal ion, then the stability constants mentioned above are the Chelant's stability constant for the chelation of the first metal ion. The Chelant's stability constant is typically determined in an equilibrium solution of aqueous 0.1M NaCl at 25° C. and pH 10 (using NaOH) through a series of potentiometric electro motive force (EMF) titrations using a Schott-Gerate GmbH Titrator TPC2000. The cell arrangement for the measurement of the hydrogen cation (H⁺) concentration is as follows:
-RE|equilibrium solution||GE+
wherein GE denotes a glass electrode, Schott N2680, and RE denotes Hg, Hg₂Cl₂||0.1 M NaCl.

Preferably the chelant is ethylene diamine-N,N′-disuccinic acid.

Anionic Detersive Surfactant System

The anionic detersive surfactant system comprises at least 50%, preferably at least 55%, or at least 60%, or at least 65%, or at least 70%, or even at least 75%, by weight of the anionic detersive surfactant system, of alkyl benzene sulphonate; preferably a linear or branched, substituted or unsubstituted, C₈₋₁₈ alkyl benzene sulphonate. This is the optimal level of the C₈₋₁₈ alkyl benzene sulphonate to provide a good cleaning performance. The C₈₋₁₈ alkyl benzene sulphonate can be a modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548. Highly preferred C₈₋₁₈ alkyl benzene sulphonates are linear C₁₀₋₁₃ alkylbenzene sulphonates. Especially preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

The C₈₋₁₈ alkyl benzene sulphonate is typically in particulate form, such as an agglomerate, a spray-dried powder, an extrudate, a bead, a noodle, a needle or a flake. It may be preferred for part of the C₈₋₁₈ alkyl benzene sulphonate to be in the form of a spray-dried powder (e.g. a blown powder), and for part of the C₈₋₁₈ alkyl benzene sulphonate to be in the form of a non-spray-dried powder (e.g. an agglomerate, or an extrudate, or a flake such as a linear alkyl benzene sulphonate flake; suitable linear alkyl benzene sulphonate flakes are supplied by Pilot Chemical under the tradename F90®, or by Stepan under the tradename Nacconol 90G®). This is especially preferred when it is desirable to incorporate high levels of the C₈₋₁₈ alkyl benzene sulphonate in the composition.

The anionic detersive surfactant preferably comprises additional adjunct anionic detersive surfactants. A preferred adjunct anionic detersive surfactant is an adjunct non-alkoxylated anionic detersive surfactant. The adjunct non-alkoxylated anionic detersive surfactant can be an alkyl sulphate, an alkyl phosphate, an alkyl phosphonate, an alkyl carboxylate or any mixture thereof. The adjunct non-alkoxylated anionic surfactant can be selected from the group consisting of; C₁₀-C₂₀ primary, branched-chain, linear-chain and random-chain alkyl sulphates (AS), typically having the following formula:
CH₃(CH₂)ₓCH₂—OSO₃⁻M⁺
wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae: 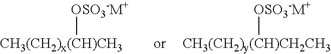
wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl carboxylates; mid-chain branched alkyl sulphates as described in more detail in U.S. Pat. No. 6,020,303 and U.S. Pat. No. 6,060,443; methyl ester sulphonate (MES); alpha-olefin sulphonate (AOS); and mixtures thereof.

It may be preferred for the adjunct non-alkoxylated anionic detersive surfactant to be structurally modified in such a manner as to cause the adjunct non-alkoxylated anionic detersive surfactant to be more calcium tolerant and less likely to precipitate out of the wash liquor in the presence of free calcium ions. This structural modification could be the introduction of a methyl or ethyl moiety in the vicinity of the adjunct non-alkoxylated anionic detersive surfactant's head group, as this can lead to a more calcium tolerant adjunct non-alkoxylated anionic detersive surfactant due to steric hindrance of the head group, which may reduce the adjunct non-alkoxylated anionic detersive surfactant's affinity for complexing with free calcium cations in such a manner as to cause precipitation out of solution. Other structural modifications include the introduction of functional moieties, such as an amine moiety, in the alkyl chain of the adjunct non-alkoxylated anionic detersive surfactant; this can lead to a more calcium tolerant adjunct non-alkoxylated anionic detersive surfactant because the presence of a functional group in the alkyl chain of an adjunct non-alkoxylated anionic detersive surfactant may minimize the undesirable physicochemical property of the adjunct non-alkoxylated anionic detersive surfactant to form a smooth crystal structure in the presence of free calcium ions in the wash liquor. This may reduce the tendency of the adjunct non-alkoxylated anionic detersive surfactant to precipitate out of solution.

The adjunct non-alkoxylated anionic detersive surfactant is typically in particulate form, such as an agglomerate, a spray-dried powder, an extrudate, a bead, a noodle, a needle or a flake. Preferably, the adjunct non-alkoxylated anionic detersive surfactant, or at least part thereof, is in agglomerate form; the agglomerate preferably comprising at least 20%, or at least 25%, or at least 30%, or at least 35%, or even at least 40%, by weight of the agglomerate, of adjunct non-alkoxylated anionic detersive surfactant, more preferably from 25% to 65%, by weight of the agglomerate, of adjunct non-alkoxylated anionic detersive surfactant. It may be preferred for part of the adjunct non-alkoxylated anionic detersive surfactant to be in the form of a spray-dried powder (e.g. a blown powder), and for part of the adjunct non-alkoxylated anionic detersive surfactant to be in the form of a non-spray-dried powder (e.g. an agglomerate, or an extrudate, or a flake). This is especially preferred when it is desirable to incorporate high levels of an adjunct non-alkoxylated anionic detersive surfactant in the composition.

Another preferred adjunct anionic detersive surfactant is an adjunct alkoxylated anionic detersive surfactant. The presence of an adjunct alkoxylated anionic detersive surfactant in the anionic detersive surfactant system provides good greasy soil cleaning performance, gives a good sudsing profile, and improves the hardness tolerance of the anionic detersive surfactant system. It may be preferred for the anionic detersive surfactant system to comprise from 1% to 50%, or from 5%, or from 10%, or from 15%, or from 20%, and to 45%, or to 40%, or to 35%, or to 30%, by weight of the anionic detersive surfactant system, of an adjunct alkoxylated anionic detersive surfactant.

Preferably, the adjunct alkoxylated anionic detersive surfactant is a linear or branched, substituted or unsubstituted C₁₂₋₁₈ alkyl alkoxylated sulphate having an average degree of alkoxylation of from 1 to 30, preferably from 1 to 10. Preferably, the adjunct alkoxylated anionic detersive surfactant is a linear or branched, substituted or unsubstituted C₁₂₋₁₈ alkyl ethoxylated sulphate having an average degree of ethoxylation of from 1 to 10. Most preferably, the adjunct alkoxylated anionic detersive surfactant is a linear unsubstituted C₁₂₋₁₈ alkyl ethoxylated sulphate having an average degree of ethoxylation of from 3 to 7.

The adjunct non-alkoxylated anionic detersive surfactant is typically in particulate form, such as an agglomerate, a spray-dried powder, an extrudate, a bead, a noodle, a needle or a flake. Preferably, at least part of, more preferably all of, the adjunct alkoxylated anionic detersive surfactant is in the form of a non-spray-dried powder such as an extrudate, agglomerate, preferably an agglomerate. This is especially preferred when it is desirable to incorporate high levels of an adjunct alkoxylated anionic detersive surfactant in the composition.

The adjunct alkoxylated anionic detersive surfactant may also increase the activity of the alkyl benzene sulphonate by making the alkyl benzene sulphonate less likely to precipitate out of solution in the presence of free calcium cations. Preferably, the weight ratio of the alkyl benzene sulphonate to the adjunct alkoxylated anionic detersive surfactant is in the range of from 1:1 to less than 5:1, or to less than 3:1, or to less than 1.7:1, or even less than 1.5:1. This ratio gives optimal whiteness maintenance performance combined with a good hardness tolerency profile and a good sudsing profile. However, it may be preferred that the weight ratio of the alkyl benzene sulphonate to the adjunct alkoxylated anionic detersive surfactant is greater than 5:1, or greater than 6:1, or greater than 7:1, or even greater than 10:1. This ratio gives optimal greasy soil cleaning performance combined with a good hardness tolerency profile, and a good sudsing profile. Suitable adjunct alkoxylated anionic detersive surfactants are: Texapan LEST™ by Cognis; Cosmacol AES™ by Sasol; BES151™ by Stephan; Empicol ESC70/U™; and mixtures thereof.

Preferably, the anionic detersive surfactant system comprises from 0% to 10%, preferably to 8%, or to 6%, or to 4%, or to 2%, or even to 1%, by weight of the anionic detersive surfactant, of unsaturated anionic detersive surfactants such as alpha-olefin sulphonate. Preferably the anionic detersive surfactant system is essentially free of unsaturated anionic detersive surfactants such as alpha-olefin sulphonate. By “essentially free of” it is typically meant “comprises no deliberately added”. Without wishing to be bound by theory, it is believed that these levels of unsaturated anionic detersive surfactants such as alpha-olefin sulphonate ensure that the anionic detersive surfactant is bleach compatible.

Preferably, the anionic detersive surfactant system comprises from 0% to 10%, preferably to 8%, or to 6%, or to 4%, or to 2%, or even to 1%, by weight of alkyl sulphate. Preferably the anionic detersive surfactant system is essentially free of alkyl sulphate. Without wishing to be bound by theory, it is believed that these levels of alkyl sulphate ensure that the anionic detersive surfactant is hardness tolerant.

Source of Peroxygen

The composition comprises a source of peroxygen that is preferably at least partially coated, more preferably essentially completely coated, by a coating ingredient. The composition preferably comprises from 1%, or from 5%, or from 10%, or from 15% and to 50%, or to 40%, or to 30%, by weight of the composition, of a source of peroxygen. The source of peroxygen includes percarbonate and/or perborate salts, preferably a percarbonate salt such as sodium percarbonate. Preferred percarbonate salts have an available oxygen content in the range of from 12 wt % to 15 wt %.

Suitable percarbonate salts are described in more detail in EP292314, EP459625, EP546815, EP567140, EP592969, EP623553, EP624549, EP654440, EP675851, EP681557, EP710215, EP746600, EP789748, EP863842, EP873971, EP968271, EP1086042, EP1227063 and GB2123044. Preferred percarbonate salts are described in more detail in EP459625, EP675851 and GB2123044. Especially preferred percarbonate salts are coated with borosilicate such as those described in more detail in EP459625 and EP675851.

Preferably the source of peroxygen is in particulate form, typically having a weight average particle size in the range of from 100 micrometers to 1,000 micrometers. Typically, the source of peroxygen has a particle size distribution such that no more than 10%, preferably no more than 5%, or even 2%, by weight of the source of peroxygen, has a particle size less than 280 micrometers, and typically no more than 10%, preferably no more than 5%, or even 2%, by weight of the source of peroxygen, has a particle size greater than 1,180 micrometers.

Coating Ingredient for Source of Peroxgyen

The source of peroxygen is preferably at least partially, more preferably essentially completely, enclosed by a coating ingredient. The coating ingredient is typically an ingredient that protects the source of peroxygen against premature decomposition during storage but is capable of releasing the source of peroxygen into the wash liquor upon contact with water. Preferred coating ingredients include: a co- or ter-polymer of vinylpyrrolidone; alkali metal salts or alkaline earth metal salts of a hydroxy carboxylic acid; an aliphatic organic compound or salt thereof, such as an aliphatic organic compound that comprises from 2 to 10 carbon atoms and one or more carboxylic acid groups; bicarbonate salts such as sodium bicarbonate; borate; borosilicate; carbonate salts such as sodium carbonate; chloride salts such as sodium chloride; citrate salts such as sodium citrate; cellulosic-based polymers such as ethyl cellulose; latex; magnesium-comprising compounds; silicate salts such as sodium silicate; sulphate salts such as lithium sulphate, magnesium sulphate and/or sodium sulphate; mixed salts of any combination of the above-described salts; and any combination thereof. Highly preferred coating ingredients are: borosilicate; carbonate salts; silicate salts; sulphate salts; any mixed salt of two or more of carbonate, silicate and sulphate; and any combination thereof. Especially preferred coating ingredients are: borosilicate; sodium carbonate; sodium silicate; sodium sulphate; a mixed sodium sulphate/carbonate salt; and any combination thereof.

Zeolite Builder

The composition comprises from 0% to less than 5%, or to 4%, or to 3%, or to 2%, or to 1%, by weight of the composition, of zeolite builder. It may even be preferred for the composition to be essentially free from zeolite builder. By essentially free from zeolite builder it is typically meant that the composition comprises no deliberately added zeolite builder. This is especially preferred if it is desirable for the composition to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

Phosphate Builder

The composition comprises from 0% to less than 5%, or to 4%, or to 3%, or to 2%, or to 1%, by weight of the composition, of phosphate builder. It may even be preferred for the composition to be essentially free from phosphate builder. By essentially free from phosphate builder it is typically meant that the composition comprises no deliberately added phosphate builder. This is especially preferred if it is desirable for the composition to have a very good environmental profile. Phosphate builders include sodium tripolyphosphate.

Silicate Salt

The composition optionally comprises from 0% to less than 5%, or to 4%,or to 3%, or to 2%, or to 1%, by weight of the composition, of a silicate salt. Whilst the composition may comprise silicate salt at a level of 5 wt % or greater, preferably the composition comprises less than 5 wt % silicate salt. It may even be preferred for the composition to be essentially free from silicate salt. By essentially free from silicate salt it is typically meant that the composition comprises no deliberately added silicate. This is especially preferred in order to ensure that the composition has a very good dispensing and dissolution profiles and to ensure that the composition provides a clear wash liquor upon dissolution in water. Silicate salts include water-insoluble silicates. Silicate salts include amorphous silicates and crystalline layered silicates (e.g. SKS-6). A preferred silicate salt is sodium silicate.

Adjunct Ingredients

The composition typically comprises adjunct ingredients. These adjunct ingredients include: detersive surfactants such as nonionic detersive surfactants, cationic detersive surfactants, zwitterionic detersive surfactants, amphoteric detersive surfactants, preferred nonionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10, preferred cationic detersive surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; carbonate salts such as sodium carbonate and/or sodium bicarbonate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as carboxylate polymers such as co-polymers of maleic acid and acrylic acid, alkoxylated polyamines and ethoxylated ethyleneimine polymers; anti-redeposition components such as carboxymethyl cellulose and polyesters; perfumes; sulphamic acid or salts thereof; citric acid or salts thereof; and dyes such as orange dye.

Preferably, the composition comprises less than 1 wt % chlorine bleach and less than 1 wt % bromine bleach. Preferably, the composition is essentially free from bromine bleach and chlorine bleach. By “essentially free from” it is typically meant “comprises no deliberately added”.

### EXAMPLES

The following solid laundry detergent compositions are in accordance with the present invention:

| | A | B | C | D | E | F |
|---|---|---|---|---|---|---|
| Spray-dried particles | | | | | | |
| C₁₀₋₁₃ linear alkyl benzene | 7.50 | 7.50 | 7.50 | 7.50 | 7.50 | 7.50 |
| sulfonate | | | | | | |
| C₁₂₋₁₆ alkyl ethoxylated | | 1.00 | 1.00 | | | |
| sulphate having an average | | | | | | |
| ethoxylation degree of 3 | | | | | | |
| Hydroxyethane di(methylene | 0.20 | 0.20 | 0.20 | 0.20 | 0.20 | 0.20 |
| phosphonic acid) | | | | | | |
| Ethylenediamine disuccinic | 0.25 | 0.25 | 0.25 | 0.25 | 0.25 | 0.25 |
| acid | | | | | | |
| Acrylate/maleate copolymer | 3.15 | 3.15 | 3.15 | 3.15 | 3.15 | 3.15 |
| Sodium carbonate | 16.50 | 18.00 | 18.00 | 16.50 | 16.50 | 16.50 |
| Fluorescent-whitening agent | 0.15 | 0.15 | 0.15 | 0.15 | 0.15 | 0.15 |
| Magnesium sulphate | 0.45 | 0.45 | 0.45 | 0.45 | 0.45 | 0.45 |
| Sodium sulphate | 21.50 | 21.50 | 21.50 | 21.50 | 21.50 | 21.50 |
| Miscellaneous and water | 4.00 | 4.00 | 4.00 | 4.00 | 4.00 | 4.00 |
| Total spray-dried particles | 53.70 | 56.20 | 56.20 | 53.70 | 53.70 | 53.70 |
| Surfactant agglomerate | | | | | | |
| C₁₂₋₁₆ alkyl ethoxylated | 6.00 | 6.00 | | 6.00 | 6.00 | 5.00 |
| sulphate having an average | | | | | | |
| ethoxylation degree of 3 | | | | | | |
| C₁₀₋₁₃ linear alkyl benzene | | | 4.00 | | | 1.00 |
| sulfonate | | | | | | |
| Sodium carbonate | 17.00 | 17.00 | 19.00 | 17.00 | 17.00 | 17.00 |
| Miscellaneous and water | 1.00 | 1.00 | 1.00 | 1.00 | 1.00 | 1.00 |
| Total surfactant agglomerate | 24.00 | 24.00 | 24.00 | 24.00 | 24.00 | 24.00 |
| Borosilicate coated | | | | | | |
| percarbonate particle | | | | | | |
| Sodium percarbonate having | 10.60 | 9.65 | 9.65 | 9.65 | 9.65 | 10.60 |
| an AvOx of 14 wt % | | | | | | |
| Borosilicate | 0.40 | 0.35 | 0.35 | 0.35 | 0.35 | 0.40 |
| Dry-added ingredients | | | | | | |
| Sodium sulphate | | | | 2.00 | | |
| Enzymes | 0.50 | 0.50 | 0.50 | 0.50 | | 0.50 |
| Tetraacetylethylenediamine | 3.00 | 2.50 | 2.50 | 2.00 | 4.50 | 3.00 |
| Citric acid | 3.00 | 2.00 | 2.00 | 3.00 | 3.00 | 3.00 |
| Suds suppressor | 0.80 | 0.80 | 0.80 | 0.80 | 0.80 | 0.80 |
| Miscellaneous and water | to 100% | to 100% | to 100% | to 100% | to 100% | to 100% |

1. A solid laundry detergent composition in particulate form, the composition comprises:
(i) an anionic detersive surfactant system that comprises at least 50%, by weight of the anionic detersive surfactant system, of alkyl benzene sulphonate;
(ii) a source of peroxygen that is at least partially coated by a coating ingredient;
(iii) a chelant;
(iv) from 0% to less than 5%, by weight of the composition, of zeolite builder;
(v) from 0% to less than 5%, by weight of the composition, of phosphate builder; and
(vi) optionally from 0% to less than 5%, by weight of the composition, of silicate salt;
wherein the chelant has a metal ion chelation efficacy such that pH 10.0, 0.1M NaCl and 25° C.:
(i) the ratio of the chelant's stability constant (log K) for Cu²⁺ ion to the chelant's stability constant (log K) for Ca²⁺ ion is greater than 1:1;
(ii) the ratio of the chelant's stability constant (log K) for Fe³⁺ ion to the chelant's stability constant (log K) for Ca²⁺ ion is greater than 1:1;
(iii) the ratio of the chelant's stability constant (log K) for Ni²⁺ ion to the chelant's stability constant (log K) for Ca²⁺ ion is greater than 1:1.

2. A composition according to claim 1, wherein the chelant is ethylene diamine-N,N′-disuccinic acid.

3. A composition according to claim 1, wherein the chelant has a metal ion chelation efficacy such that:
(i) the ratio of the chelant's stability constant (log K) for Cu²⁺ ion to the chelant's stability constant (log K) for Ca²⁺ ion is greater than 2:1;
(ii) the ratio of the chelant's stability constant (log K) for Fe³⁺ ion to the chelant's stability constant (log K) for Ca²⁺ ion is greater than 2:1;
(iii) the ratio of the chelant's stability constant (log K) for Ni²⁺ ion to the chelant's stability constant (log K) for Ca²⁺ ion is greater than 2:1.

4. A composition according to claim 1, wherein the chelant has a metal ion chelation efficacy such that:
(i) the ratio of the chelant's stability constant (log K) for Cu²⁺ ion to the chelant's stability constant (log K) for Ca²⁺ ion is greater than 3:1;
(ii) the ratio of the chelant's stability constant (log K) for Fe³⁺ ion to the chelant's stability constant (log K) for Ca²⁺ ion is greater than 3:1;
(iii) the ratio of the chelant's stability constant (log K) for Ni²⁺ ion to the chelant's stability constant (log K) for Ca²⁺ ion is greater than 3:1.

5. A composition according to claim 1, wherein the chelant and the source of peroxygen are present in the composition in the form of separate particulate components, and wherein the ratio of the porosity of the particulate component comprising the chelant to the porosity of the particulate component comprising the source of peroxygen is greater than 1:1.

6. A composition according to claim 1, wherein the ratio of the average particle size of the particulate component comprising the chelant to the average particle size of the particulate component comprising the source of peroxygen is in the range of from 0.0001:1 to 1000:1.

7. A composition according to claim 1, wherein the chelant and an anionic detersive surfactant are present in the composition in the form of a co-particulate admix.

8. A composition according to claim 1, wherein the anionic detersive surfactant system additional comprises a linear or branched, substituted or unsubstituted, C₈₋₁₈ alkyl alkoxylated sulphate having an average degree of alkoxylation of from 1 to 10.

9. A composition according to claim 1, wherein the anionic detersive surfactant system comprises:
(i) from 0% to 4%, by weight of the anionic detersive surfactant system, of an alpha-olefin sulphonate; and
(ii) from 0% to 4%, by weight of the anionic detersive surfactant system, of alkyl sulphate.

10. A solid laundry detergent composition in particulate form, the composition comprises:
(i) an anionic detersive surfactant system that comprises at least 50%, by weight of the anionic detersive surfactant system, of alkyl benzene sulphonate;
(ii) a source of peroxygen that is at least partially coated by a coating ingredient;
(iii) ethylene diamine-N,N′-disuccinic acid;
(iv) from 0% to less than 5%, by weight of the composition, of zeolite builder;
(v) from 0% to less than 5%, by weight of the composition, of phosphate builder; and
(vi) optionally from 0% to less than 5%, by weight of the composition, of silicate salt.
